(19) United States
(12) Patent Application Publication
(10) Pub. No.: US 2025/0067497 A1
(43) Pub. Date: Feb. 27, 2025

(54) Food-Cooling Device

(71) Applicant: Lisa Reimers, Grey Eagle, MN (US)

(72) Inventor: Lisa Reimers, Grey Eagle, MN (US)

(21) Appl. No.: 18/786,720

(22) Filed: Jul. 29, 2024

Related U.S. Application Data
(60) Provisional application No. 63/520,746, filed on Aug. 21, 2023.

(51) Int. Cl. F25D 11/00; F25D 29/00

(52) U.S. Cl. CPC F25D 11/003; F25D 29/003; F25D 2400/361

(57) ABSTRACT

A food-cooling device is provided. The device is designed to maintain a consistent temperature for stored food and is comprised of a body made from insulating material, at least one cooling element, a removable inner body, and a lid. The cooling element's temperature is adjustable via controls on the body, which may include a touchscreen display or physical buttons, and can be preset for specific food types. Additionally, the device includes a timer for setting operational durations and can be controlled remotely through a mobile application that communicates wirelessly with the device, allowing users to select cooling temperatures and configure the timer. The device is powered by a battery, which can be either removable or non-removable and is capable of being recharged or powered directly from a power source.

### CROSS-REFERENCE TO RELATED APPLICATION

The present application claims priority to, and the benefit of, U.S. Provisional Application No. 63/520,746, which was filed on Aug. 21, 2023, and is incorporated herein by reference in its entirety.

### FIELD OF THE INVENTION

The present invention relates generally to the field of food storage devices. More specifically, the present invention relates to a food-cooling device that cools food placed in or on the device at a constant temperature for a desired period of time. Accordingly, the present disclosure makes specific reference thereto. Nonetheless, it is to be appreciated that aspects of the present invention are also equally applicable to other like applications, devices, and methods of manufacture.

### BACKGROUND

Foods that require refrigeration to remain fresh and safe for consumption, such as salads, pasta salads, vegetables, fruits, and various other items typically enjoyed in a chilled state, are particularly susceptible to spoilage if not maintained at an appropriate temperature. This challenge becomes more pronounced when considering the logistics of preserving these foods over extended periods, especially in scenarios where traditional cooling methods such as refrigeration or freezing are not readily available. For instance, during outdoor gatherings, picnics, or events where access to electrical appliances is limited or nonexistent, ensuring the freshness and safety of perishable items can become a daunting task.

Moreover, the common practice of utilizing coolers filled with ice as a makeshift refrigeration method comes with its own set of complications. While this approach can provide a temporary solution for keeping food items cool, it is often fraught with potential issues. For example, the process of packing and unpacking these containers can be cumbersome, and there is always the risk of water ingress as the ice melts, which can lead to the food becoming waterlogged. This not only compromises the texture and taste of the food but also raises concerns about its overall safety for consumption. Additionally, the presence of melted ice and water within the cooler can create a messy and unhygienic environment, further exacerbating the problem.

Therefore, there exists a long-felt need in the art for an improved cooling device for food. There also exists a long-felt need in the art for a food-cooling device. More specifically, there exists a long-felt need in the art for a food-cooling device wherein the device can be used to keep food cool at a consistent temperature. Further, there exists a long-felt need in the art for a food-cooling device wherein the device can be used to keep food cool at a consistent temperature for a desired period of time. In addition, there exists a long-felt need in the art for a food-cooling device wherein the device can be used to keep food cool at a consistent temperature for a desired period of time wherein the food does not become waterlogged inside the device.

The subject matter disclosed and claimed herein, in one embodiment thereof, comprises a food-cooling device. The device is designed to maintain a consistent temperature for stored food and is comprised of a body made from insulating material, at least one cooling element, a removable inner body, and a lid. The cooling element's temperature is adjustable via controls on the body, which may include a touchscreen display or physical buttons, and can be preset for specific food types. Additionally, the device includes a timer for setting operational durations and can be controlled remotely through a mobile application that communicates wirelessly with the device, allowing users to select cooling temperatures and configure the timer. The device is powered by a battery, which can be either removable or non-removable and is capable of being recharged or powered directly from a power source.

In this manner, the food-cooling device of the present invention accomplishes all the forgoing objectives and provides an improved cooling device for food that can be used to keep food cool at a consistent temperature for a desired period of time. While doing so, the food does not become waterlogged inside the device. In addition, the device can be used away from power sources such as power outlets.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a food-cooling device. In one embodiment, a body of the device receives at least one removable inner body. The device is also comprised of at least one lid. In one embodiment, the lid can be removably secured to the body and/or inner body via at least one fastener.

The body is further comprised of at least one cooling element. In one embodiment, the cooling element ensures the interior of the body (i.e., wherein the inner body is positioned and where food is stored during use) remains at a consistent temperature. The cooling element may include but is not limited to a cooling liquid, a cooling gel, an air condenser, a vent, a fan, etc. The temperature of the cooling element may be controlled by at least one control located on the body. The control may be a physical control (i.e. a button, knob, etc.) or a touchscreen display. Cooling temperatures of the element may be pre-selected at specific temperatures (which can then be selected by the control) based upon the type/style of food being stored within the device. The device is also comprised of at least one timer that allows the element to run for a period of time and then shut off.

In one embodiment, the device is comprised of a mobile application that can be installed on a smart device. The application allows a user to select a cooling temperature of the element. A second function allows a user to configure the timer such that the cooling element cools for a specific period of time.

The device is also comprised of at least one battery. In one embodiment, the battery allows the device to operate without a power source/power outlet. In a different embodiment, the battery can receive power from a power source/power outlet via at least one power cord of any configuration. In a further embodiment, the battery may be comprised of at least one charging port that allows the battery to charge.

The present invention is also comprised of a first method of using the device. First, a device is provided comprised of a body comprised of at least one cooling element, at least one inner body, and at least one lid. Then, the inner body can be placed inside the body and wherein food can then be placed inside the inner body. Next, the lid can be placed onto the body. Finally, a temperature of the cooling element and a run-time duration of the cooling element can be configured via a control and/or a mobile application.

Accordingly, the food-cooling device of the present invention is particularly advantageous as it provides an improved cooling device for food that can be used to keep food cool at a consistent temperature for a desired period of time. While doing so, the food does not become waterlogged inside the device. In addition, the device can be used away from power sources such as power outlets. In this manner, the food-cooling device overcomes the limitations of existing food-cooling and storing devices (and methods) known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a food-cooling device of the present invention while assembled and closed in accordance with the disclosed architecture;

FIG. 2 illustrates a perspective view of one potential embodiment of a food-cooling device of the present invention while assembled and closed in accordance with the disclosed architecture;

FIG. 3 illustrates a perspective exploded view of one potential embodiment of a food-cooling device of the present invention in accordance with the disclosed architecture;

FIG. 4 illustrates a graphical view of a mobile application of one potential embodiment of a food-cooling device of the present invention in accordance with the disclosed architecture;

FIG. 5 illustrates a flowchart of a method of using one potential embodiment of a food-cooling device of the present invention in accordance with the disclosed architecture; and

FIG. 6 illustrates a flowchart of a method of using one potential embodiment of a food-cooling device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cooling device for food. There also exists a long-felt need in the art for a food-cooling device. More specifically, there exists a long-felt need in the art for a food-cooling device wherein the device can be used to keep food cool at a consistent temperature. Further, there exists a long-felt need in the art for a food-cooling device wherein the device can be used to keep food cool at a consistent temperature for a desired period of time. In addition, there exists a long-felt need in the art for a food-cooling device wherein the device can be used to keep food cool at a consistent temperature for a desired period of time wherein the food does not become waterlogged inside the device.

The present invention, in one exemplary embodiment, is comprised of a food-cooling device. In one embodiment, a body of the device receives at least one removable inner body. The device is also comprised of at least one lid in this embodiment. In one embodiment, the lid can be removably secured to the body and/or inner body via at least one fastener.

The body is further comprised of at least one cooling element that ensures the interior of the body (i.e., wherein the inner body is positioned and where food is stored during use) remains at a consistent temperature. The cooling element may include but is not limited to a cooling liquid, a cooling gel, an air condenser, a vent, a fan, etc. The temperature of the cooling element may be controlled by at least one control located on the body, wherein the control may be a physical control (i.e. a button, knob, etc.) or a touchscreen display. Cooling temperatures of the element may be pre-selected at specific temperatures (which can then be selected by the control) based upon the type/style of food being stored within the device. The device is also comprised of at least one timer that allows the element to run for a period of time and then shut off.

In one embodiment, the device is comprised of a mobile application that can be installed on a smart device. The application allows a user to select a cooling temperature of the element. A second function allows a user to configure the timer such that the cooling element cools for a specific period of time.

The device is also comprised of at least one battery. In one embodiment, the battery allows the device to operate without a power source/power outlet. In a different embodiment, the battery can receive power from a power source/power outlet via at least one power cord of any configuration. In a further embodiment, the battery may be comprised of at least one charging port that allows the battery to charge.

The present invention is also comprised of a first method of using the device. First, a device is provided comprised of a body comprised of at least one cooling element, at least one inner body, and at least one lid. Then, the inner body can be placed inside the body and wherein food can then be placed inside the inner body. Next, the lid can be placed onto the body. Finally, a temperature of the cooling element and a run-time duration of the cooling element can be configured via a control and/or a mobile application.

Accordingly, the food-cooling device of the present invention is particularly advantageous as it provides an improved cooling device for food that can be used to keep food cool at a consistent temperature for a desired period of time. While doing so, the food does not become waterlogged inside the device. In addition, the device can be used away from power sources such as power outlets. In this manner, the food-cooling device overcomes the limitations of existing food-cooling and storing devices (and methods) known in the art.

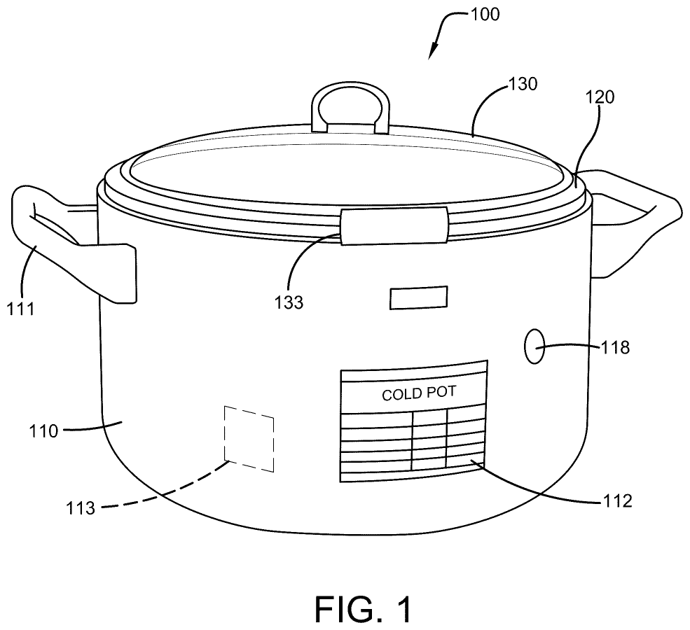

Referring initially to the drawings, FIG. 1 illustrates a perspective view of one potential embodiment of a food-cooling device 100 of the present invention while assembled and closed in accordance with the disclosed architecture. The device 100 is comprised of a body 110 with at least one cooling element 113, at least one removable inner body 120, and at least one lid 130.

The body 110 may be any size, shape, and configuration in different embodiments. The body 110 is preferably made from an insulating material such as but not limited to double-walled stainless steel. The body 110 may be comprised of at least one handle 111 of any style/configuration to aid in lifting the body 110.

The body 110 receives at least one removable inner body 120 in one embodiment. The inner body 120 may be any size, shape, and configuration such that it fits within the body 110. The inner body 120 may be made from any food-grade material known in the art. In one embodiment, an interior surface 121 of the body 120 is comprised of a non-stick coating 122 that prevents food from sticking to the inner body 120 while being stored within the device 100. In another embodiment, the body 110 has a flat cooling element 113 and no inner body 120 such that a plate with food can be set directly on the body 110 for cooling.

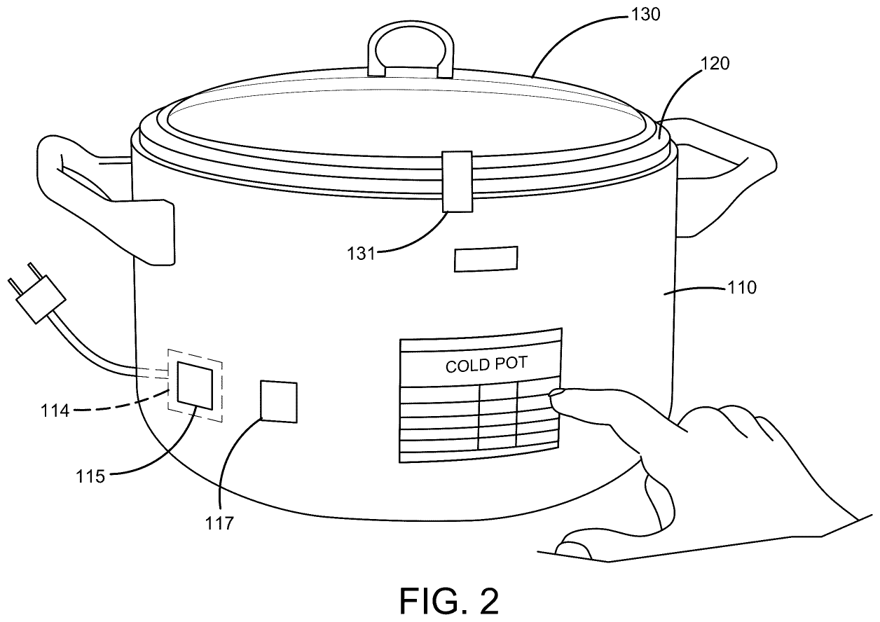

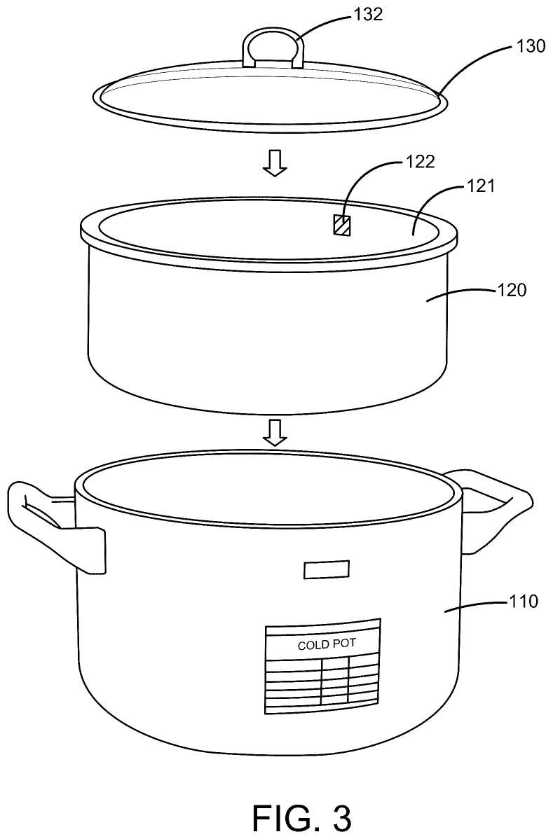

The device 100 is also comprised of at least one lid 130. The lid 130 may be any size, shape, and configuration. The lid 130 may be made from any material that may be transparent or opaque. The lid 130 may be comprised of at least one handle 132 of any style/configuration to aid in lifting the lid 130. In one embodiment, the lid 130 can be removably secured to the body 110 and/or inner body 120 via at least one fastener 131, as seen in FIG. 2. The fastener 131 prevents the lid 130 from falling off during transport, if bumped, etc. The fastener 131 may include but is not limited to a clip, a clamp, a latch, a button lock, a twist lock, etc. In one embodiment, the lid 130 attaches to the body 110 via at least one hinge 133, as seen in FIG. 3.

The body 110 is comprised of at least one cooling element 113. The cooling element 113 ensures the interior of the body 110 (i.e., wherein the inner body 120 is positioned and where food is stored during use) remains at a consistent temperature. The cooling element 113 may include but is not limited to a cooling liquid, a cooling gel, an air condenser, a vent, a fan, etc. The temperature of the cooling element 113 may be controlled by at least one control 112 located on the body 110. The control 112 may be a physical control (i.e. a button, knob, etc.) or a touchscreen display. Cooling temperatures of the element 113 may be pre-selected at specific temperatures (which can then be selected by the control 112) based upon the type/style of food being stored within the device 100. The device 100 is also comprised of at least one timer 118 that allows the element 113 to run for a period of time and then shut off.

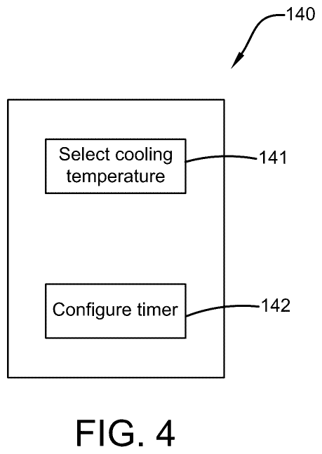

In one embodiment, the device 100 is comprised of a mobile application 140 that can be installed on a smart device such as but not limited to a smartphone, a tablet, a computer, etc., as represented in FIG. 4. Said smart device is preferably in wireless electrical communication with the cooling element 113 and/or timer 118 via at least one wireless receiver 117 of the body 110. In this manner, a first function of the application 140 allows a user to select a cooling temperature 141 of the element 113. A second function 142 allows a user to configure the timer 118 such that the cooling element 113 cools for a specific period of time.

The device 100 is also comprised of at least one battery 114. The battery 114 may be removable or non-removable and rechargeable or disposable in different embodiments. In one embodiment, the battery 114 allows the device 100 to operate without a power source/power outlet. In a different embodiment, the battery 114 can receive power from a power source/power outlet via at least one power cord 116 of any configuration. In a further embodiment, the battery 114 may be comprised of at least one charging port 115 that allows the battery 114 to charge.

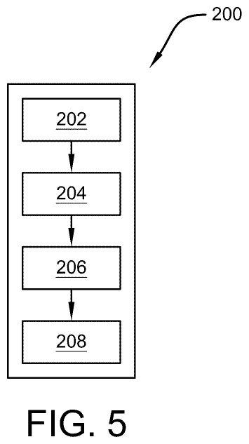

The present invention is also comprised of a method of using 200 the device 100, as seen in FIG. 5. First, a device 100 is provided comprised of a body 110 comprised of at least one cooling element 113, at least one inner body 120, and at least one lid 130 [Step 202]. Then, the inner body 120 can be placed inside the body 110 and wherein food can then be placed inside the inner body 120 [Step 204]. Next, the lid 130 can be placed onto the body 110 [Step 206]. Finally, a temperature of the cooling element 113 and a run-time duration of the cooling element 113 can be configured via a control 112 and/or a mobile application 140 [Step 208].

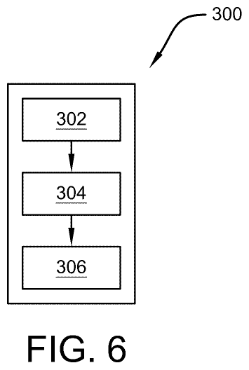

The present invention is also comprised of a second method of using 300 the device 100, as seen in FIG. 6. First, a device 100 is provided comprised of a body 110 comprised of at least one cooling element 113 [Step 302]. Then, a user can place a plate (or other similar dishware) onto the cooling element 113 [Step 304]. Finally, a temperature of the cooling element 113 and a run-time duration of the cooling element 113 can be configured via a control 112 and/or a mobile application 140 [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “food-cooling device” and “device” are interchangeable and refer to the food-cooling device 100 of the present invention.

Notwithstanding the forgoing, the food-cooling device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the food-cooling device 100 as shown in the FIGS. are for illustrative purposes only, and that many other sizes and shapes of the food-cooling device 100 are well within the scope of the present disclosure. Although the dimensions of the food-cooling device 100 are important design parameters for user convenience, the food-cooling device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A food-cooling device comprising:
a body comprised of a cooling element;
a control that controls a temperature of the cooling element;
an inner body; and
a lid.

2. The food-cooling device of claim 1, wherein the body is comprised of an insulating material.

3. The food-cooling device of claim 1, wherein the inner body is comprised of a non-stick coating.

4. The food-cooling device of claim 1 further comprised of a fastener.

5. The food-cooling device of claim 4, wherein the fastener secures the lid to the body.

6. The food-cooling device of claim 1, wherein the cooling element is comprised of a cooling liquid, a cooling gel, an air condenser, a vent, or a fan.

7. The food-cooling device of claim 1, wherein the control is comprised of a button or a knob.

8. The food-cooling device of claim 1, wherein the control is comprised of a touchscreen display.

9. A food-cooling device comprising:
a body comprised of a cooling element;
a control that controls a temperature of the cooling element;
a timer; and
mobile application.

10. The food-cooling device of claim 9, wherein the timer controls the run-time of the cooling element.

11. The food-cooling device of claim 9, wherein the timer is controlled by the mobile application.

12. The food-cooling device of claim 9, wherein the control is controlled by the mobile application.

13. The food-cooling device of claim 9 further comprised of a battery.

14. The food-cooling device of claim 13, wherein the battery is comprised of a charging port.

15. The food-cooling device of claim 9 further comprised of a power cord.

16. A method of using a food-cooling device, the method comprising the following steps:
providing a food-cooling device comprised of a body comprised of a cooling element, an inner body, and a lid;
placing the inner body inside the body and placing a food in the inner body;
placing a lid on the body; and
configuring a temperature and a run-time of the cooling element.

17. The method of using a food-cooling device of claim 16, wherein the food-cooling device is comprised of a control.

18. The method of using a food-cooling device of claim 16, wherein the food-cooling device is comprised of a timer.

19. The method of using a food-cooling device of claim 17, wherein the food-cooling device is comprised of a mobile application that controls the control.

20. The method of using a food-cooling device of claim 18, wherein the food-cooling device is comprised of a mobile application that controls the timer.
